(19) United States
(12) Patent Application Publication
(10) Pub. No.: US 2026/0245931 A1
(43) Pub. Date: Aug. 20, 2026

(54) INSPECTION METHOD FOR CONTROLLING THE OPENING DURATION OF AN OUTLET VALVE OF A LIQUID CONTAINER IN AN ANODE EXHAUST SECTION OF A FUEL CELL SYSTEM

(71) Applicant: AVL List GmbH, Graz (AT)

(72) Inventors: Katharina WEINGRILL, Stallhofen (AT); David WEINGRILL, Stallhofen (AT)

(73) Assignee: AVL List GmbH, Graz (AT)

(21) Appl. No.: 19/469,406

(22) PCT Filed: Mar. 26, 2024
(86) PCT No.: PCT/AT2024/060108

§ 371 Date: Sep. 26, 2025

(30) Foreign Application Priority Data
Mar. 27, 2023 (AT) A 50223/2023

(51) Int. Cl. H01M 8/0438; H01M 8/04119; H01M 8/04746; H01M 8/04828

(52) U.S. Cl. CPC H01M 8/04402; H01M 8/04156; H01M 8/04761; H01M 8/04835

(57) ABSTRACT

The present invention relates to an inspection method for controlling an opening duration (OD) of an outlet valve (142) of a liquid container (140) in an anode exhaust gas section (124) of a fuel cell system (100), wherein the following steps are provided:
opening the outlet valve (142) to drain liquid (F) from the liquid container (140),
recording the anode pressure (AP) in the anode exhaust gas section (124) at the time of opening the outlet valve (142),
setting an anode pressure reference value (APR) based on the recorded anode pressure (AP),
further monitoring of the anode pressure (AP) during the opening duration (OD) of the outlet valve (142),
determining an anode pressure deviation (APA) of the monitored anode pressure (AP) from the set anode pressure reference value (APR),
closing the outlet valve (142) when the determined anode pressure deviation (APA) exceeds a deviation threshold (AG).

The present invention relates to an inspection method for controlling an opening duration of an outlet valve of a liquid container in an anode exhaust gas section of a fuel cell system, a control device for carrying out such an inspection method, a computer program product for executing such an inspection method, and a fuel cell system having a corresponding control device.

It is known that fuel cell systems also generate moisture, among other things, during their operation to generate electrical power. This moisture is present in both gaseous and liquid phases and is transported away with the anode exhaust gas. It is thereby necessary, especially during the recirculation of such anode exhaust gas, that the resulting and condensed water is separated in order to avoid damage, in particular due to flooding of gas pipes for the anode exhaust gas and/or the anode supply gas. Known fuel cell systems are therefore equipped with water separators that separate condensed water droplets from the anode exhaust gas and thus dry it. As is known, the separated water from the anode exhaust gas is captured in a liquid container and collected there. Because the liquid container has a finite capacity, it must be emptied at specified intervals so that the liquid contained therein, in the form of the separated water, is discharged into the environment. This process can also be referred to as a drain process. It is also known that in addition to the process of draining separated water, part of the recirculated anode exhaust gas is discharged into the environment in order to influence the composition of an anode supply gas in a desired way and, in particular, to vary the fuel gas content. This process of discharging anode exhaust gas can be referred to as a purge process.

The known inspection methods are based on the fact that, at a defined maximum fill level of the liquid container, a corresponding outlet valve is opened, and the liquid is drained. This ensures that, with the known inspection methods, the liquid container substantially empties completely, i.e. all of the liquid leaves the liquid container. This means that at the end of this draining process, at least for a short period of time, no more liquid passes through the outlet valve. At this point, there is no longer any liquid in the liquid container, but the outlet valve is still open. The result is that, over this residual opening time of the outlet valve, anode exhaust gas flows through the outlet valve in a gaseous manner and escapes into the environment.

A disadvantage of known inspection methods is that the escape of the anode exhaust gas after the liquid container has been completely emptied is not taken into account for subsequent purge processes. In other words, with each drain process, i.e. with each opening cycle of the outlet valve, the fuel cell system loses not only the liquid from the liquid container, as desired, but also anode exhaust gas which, depending on the operating condition, still contains a residual amount of fuel. This loss, which is not taken into account for other control steps, leads to reduced efficiency in the operation of the fuel cell system.

It is the object of the present invention to remedy, at least in part, the problems described above. In particular, the object of the present invention is to reduce the loss of fuel during drain processes in a cost-effective and simple manner.

The above object is achieved by an inspection method having the features of claim 1, a control device having the features of claim 11, a computer program product having the features of claim 12 and a fuel cell system having the features of claim 13. Further features and details of the invention are disclosed in the dependent claims, the description and the drawings. Naturally, features and details described in connection with the inspection method according to the invention also apply in connection with the control device according to the invention, the computer program product according to the invention and the fuel cell system according to the invention and vice versa, so that with regard to disclosure mutual reference is or can always be made to the individual aspects of the invention.

An inspection method according to the invention is used to control an opening duration of an outlet valve of a liquid container in an anode exhaust gas section of a fuel cell system. Such an inspection method is characterised by the following steps:
opening the outlet valve to drain liquid from the liquid container,
recording the anode pressure in the anode exhaust gas section at the time of opening the outlet valve,
setting an anode pressure reference value based on the recorded anode pressure,
further monitoring of the anode pressure during the opening duration of the outlet valve,
determining an anode pressure deviation of the monitored anode pressure from the set anode pressure reference value,
closing the outlet valve when the determined anode pressure deviation exceeds a deviation threshold.

An inspection method according to the invention is based on the fundamental necessity for liquid which has been separated from the anode exhaust gas into a liquid container and collected therein needs to be discharged from this liquid container. For this purpose, the fuel cell system, which is also part of the present invention, as described later, is equipped with a liquid container. This liquid container serves to receive and collect water which is separated in liquid form from the anode exhaust gas. According to the invention, the outlet valve can be opened as in the prior art, for example based on a monitoring of the fill level in the liquid container. As soon as the outlet valve is opened, liquid will pass out of the liquid container through the outlet valve. A direct discharge into the environment may be provided for, but also a discharge for other subsequent treatments or uses within the scope of the present invention. In other words, the time of opening the outlet valve defines the start of the opening process of the outlet valve and, for the purposes of the present invention, the beginning of the opening duration of this outlet valve.

As soon as the outlet valve has been opened, the anode pressure is recorded at this time of opening the outlet valve. The anode pressure is thereby recorded in particular in the anode exhaust gas section, in particular upstream of the outlet valve or in particular directly at the anode outlet. However, an indirect determination, for example in the anode supply section, is also conceivable in order to ensure an indirect recording or determination of the anode pressure. The anode pressure at the time of opening the outlet valve is thus the current pressure situation that exists for this defined operating situation when the opening duration and thus the opening process of the outlet valve begins. Since this is the reference situation which is specific to the current operating situation of the fuel cell system, exactly this anode pressure recorded at the time of opening the outlet valve is used as the basis for an anode pressure reference value in an inspection method according to the invention. In the simplest case, the recorded anode pressure is set directly as the anode pressure reference value. However, other processing may also be provided, for example the use of the anode pressure supplemented by a safety margin to set the anode pressure reference value.

As soon as the anode pressure reference value for the specific operating situation of the fuel cell system has been set, further monitoring of the anode pressure takes place over the opening duration of the outlet valve. In other words, the anode pressure is used once at the start of the opening process to set the anode pressure reference value and is then monitored further, preferably continuously. This further monitoring of the anode pressure serves to determine an anode pressure deviation from the set anode pressure reference value, again preferably continuously. In other words, it can now be seen to what extent the anode pressure varies from the set anode pressure reference value over the opening process. As soon as the anode pressure deviation exceeds a defined deviation threshold, this causes the outlet valve to be closed again. This comparison-based closing mechanism is based on the fact that it can be assumed that the liquid container is empty at the end of the opening process. As soon as the last remaining amount of liquid has been drained from the liquid container through the outlet valve, the anode pressure, which is being continuously monitored, drops rapidly. This is due to the fact that no residual liquid remaining in the liquid container now forms a pressure block against the anode exhaust gas section; rather, at this point in time the anode exhaust gas, in a gaseous state, begins to escape into the environment through the outlet valve. This leakage leads to the monitored anode pressure now decreasing compared to the anode pressure reference value, and the anode pressure deviation will increase accordingly. This increase is recorded and, through the comparison with the deviation threshold, used to close the outlet valve at this time.

In the method according to the invention, in particular, the pressure itself is not taken into account, but rather only an output of the pressure controller. The latter tries to adjust its setpoint value. When a gas phase is detected, the pressure controller thus adjusts the gas supply to keep the pressure constant.

Thus, according to the invention, the inspection method further serves to ensure the primary function of timely emptying of the liquid container. However, in contrast to the known inspection methods, the opening duration is designed to be variable, namely as a functional relationship between the anode pressure and a current operating situation of the fuel cell system in the form of the anode pressure reference value. Here, two key advantages of the present invention are clear to see. On the one hand, the drain process reacts actively to the actual operating situation in the liquid container, i.e. depending on how much liquid is present in the liquid container and how long it actually takes to drain the liquid container until it is completely emptied. On the other hand, the current operating situation of the fuel cell system is also taken into account, in particular the parameter values for the resulting anode pressure, which vary depending on the operating situation. This means that the drain process can be varied cost-effectively and easily, and yet flexibly, in such a way that a maximum emptying of the liquid container can always be combined with a minimal gas leakage of anode exhaust gas.

Compared to the known solutions with fixed drain processes in outlet valves, this leads to significantly less anode exhaust gas being lost during each opening process of the outlet valve, thus making it possible to significantly improve the efficiency of the entire fuel cell system in operation when generating electrical power. An incidental advantage can be that the number of necessary openings can be reduced, as only the variable necessary opening duration needs to be used to completely empty the liquid container. Also, as will be explained later, a feedback of the information about the amount of liquid drained off can be used to adjust the period until the next opening process in such a way that an optimised opening duration and/or an optimised period duration can be achieved for each opening of the outlet valve. The number of opening processes and, in particular, the interval between opening processes can be optimised in this way. In addition, losses are also further reduced. Since the function is based on the detection of the gas phase, part of the gas always also flows out. If the opening processes are optimised, the outlet valve can already be closed before the function responds.

It should also be pointed out that the deviation threshold can both be a fixed specification and represent a variable form. For example, the deviation threshold can be based, in a functional context, on the operating situation of the fuel cell system or on the previous fill level of the liquid container.

It can be advantageous if, in an inspection method according to the invention, a maximum opening duration is specified, whereby the outlet valve is closed when the maximum opening duration is reached. This leads to an additional condition with regard to the opening process. For example, with regard to subsequent treatment, but also with regard to the stability of the operating state of the fuel cell system, it may be desirable that a maximum duration of the opening process is not exceeded. By providing a maximum opening duration, it is ensured that the outlet valve is closed even if, while this maximum opening duration has been reached, the liquid container has not yet completely emptied and thus the anode pressure deviation has not yet exceeded the deviation threshold. This provides an additional condition that can further improve the operational stability, in particular of the fuel cell system. In such a case, the period until the next opening of the outlet valve can for example be actively shortened.

It can also be advantageous if, in an inspection method in accordance with the preceding paragraph, the maximum opening duration is specified on the basis of at least one operating parameter of the fuel cell system. Since the maximum opening duration relates in particular to an increase in stability in the operation of the fuel cell system, in this case, a variable design can take into account the actual current operating situation of the fuel cell system. In particular, operating parameters such as the current generated by the fuel cell stack, the temperature in the fuel cell stack and/or the different pressures in the fuel cell stack are relevant influencing parameters for a maximum opening duration. Of course, the frequency of the outlet valve opening processes and/or the time at which the outlet valve opening process is started can also be included in the adjustment of the maximum opening duration.

It is also advantageous if, in an inspection method according to the invention, a minimum opening duration is specified, whereby the outlet valve remains open at least during the minimum opening time. As opposed to the maximum opening duration as an upper limit, this represents a lower limit that provides a minimum opening time. In other words, after opening the outlet valve, this outlet valve will now remain open at least until the minimum opening time is actually exceeded. This also applies if the anode pressure deviation exceeds the deviation threshold earlier, so that in this way it is ensured that no unnecessarily fast switching of the outlet valve can take place, e.g. due to high dynamics, in particular in a way that damages the valve. This can be done in combination with or separately from the use of the maximum opening duration.

It can bring further advantages if, in an inspection method according to the invention, during the opening duration and/or after the closing of the outlet valve, a discharged amount of liquid is determined on the basis of the opening duration. Not only qualitative monitoring and control interventions, but also quantitative control is possible here. Thus, on the basis of the total opening duration, in particular on the basis of the known geometry of the outlet valve, a determination can now be carried out as to which volume flow and thus what total amount of liquid has been discharged through the outlet valve during the opening duration. In particular, use is made of a known volume flow rate through a known opening geometry of the outlet valve. However, additional physical parameters, in particular the driving force for the drain, which for example uses a gravity-based drain function or, on the basis of the anode pressure, a pressurised driving force for the drain function. It is also possible to compare the discharged and thus determined amount with the respective amount of the last opening process, so that a correction of the opening period becomes possible, to ensure that the total number of opening processes as well as the period between the individual opening processes can be further optimised for the inspection method.

In addition, it brings advantages if, in an inspection method according to the invention, the anode pressure reference value corresponds exactly to the recorded anode pressure at the time of opening the outlet valve. This is to be understood to mean that an additional algorithmic processing of the anode pressure is no longer necessary, as it can be set directly and exactly as the anode pressure reference value. Alternatively, a variable or flexible design of the anode pressure reference value is possible, but also the algorithmic correlation to the recorded anode pressure, which correlation is described below. If the anode pressure reference value is fixed, in particular the anode pressure is no longer adjusted in the event of a change in the operating situation during the opening process; rather, the anode pressure reference value is kept constant throughout the opening process, even in the event of different and changing operating situations of the fuel cell system.

As an alternative to the preceding paragraph, it is possible that, in an inspection method according to the invention, the anode pressure reference value corresponds to the recorded anode pressure at the time of opening the outlet valve plus a safety margin. In other words, in this case the recorded anode pressure is used, a safety margin is added and then this combination is set as the anode pressure reference value. For example, expected fluctuations, latencies or measurement inaccuracies can be directly taken into account and, so to speak, compensated for in advance, and integrated into the anode pressure reference value optimised in this way.

It is also advantageous if, in an inspection method according to the invention, the anode pressure reference value is varied over the opening duration on the basis of an anode supply pressure in an anode supply section of the fuel cell system. Since the anode pressure is now dependent on the operating state of the fuel cell system, continuously adjusting the anode pressure reference value can bring advantages in the case of longer opening durations of the outlet valve. For example, if it is detected, through monitoring of an anode supply pressure in the anode supply section, that the fuel cell system is changing its operating situation, with increased anode supply pressure, for example, it can accordingly be assumed that the anode pressure in the region of the anode gas section also increases as a result. The anode pressure reference value set at the beginning of the outlet valve opening no longer fits this changed operating situation of the fuel cell system. By including a changing anode supply pressure in a continuous adjustment of the anode pressure reference value, it is ensured that, even in highly dynamic load situations with rapidly changing operating situations of the fuel cell system, the advantages of an inspection method according to the invention remain relevant and can still be achieved.

It can also be advantageous if, in an inspection method according to the invention, the outlet valve is closed immediately when the deviation threshold is exceeded. As an alternative to immediate closure, a defined over-run is also possible, in order to be able to determine a defined gas loss of an anode exhaust gas, in particular over this over-run time, as explained later. However, immediate closure leads to a further optimisation in terms of the advantage of increased efficiency in the operation of the fuel cell system, since the amount of loss in terms of anode exhaust gas can be reduced to a minimum.

It can be particularly advantageous if the function is suspended if the deviation threshold is exceeded, and a reference opening duration or a maximum opening duration is used instead.

Furthermore, it is advantageous if, in an inspection method according to the invention, an over-run duration is determined from the exceeding of the deviation threshold until the deviation threshold is complied with again after the outlet valve has been closed, wherein, in particular on the basis of the determined over-run duration, an amount of anode exhaust gas lost through the opened outlet valve is determined. It is easy to see here how a quantitative evaluation of the inspection method and a corresponding feedback into the control loop is also possible with regard to the gas phase. Since the over-run duration is known with regard to the overshoot in the control, i.e. the time until the control step in the form of closing the outlet valve achieves its effect in the form of falling below the deviation threshold, a defined over-run duration can be determined. Using the known geometry of the outlet valve, it is now possible also to determine the amount of anode exhaust gas lost over this over-run duration, so that this can be taken into account for the next purge process, for example. In other words, not only is the amount of lost gas in the form of anode exhaust gas minimised, but the actual amount of lost gas in the form of anode exhaust gas can also be determined. This determination means that efficiency can be increased even further, since it is possible to take it into account for the subsequent purge processes.

The subject matter of the present invention also includes a control device for controlling an opening duration of an outlet valve of a liquid container in an anode exhaust gas section of a fuel cell system. Such a control device is characterised in that an opening module is provided for opening the outlet valve to discharge liquid from the liquid container. Furthermore, a recording module is provided for recording the anode pressure in an anode exhaust gas section at the time of opening the outlet valve. With the aid of a setting module, an anode pressure reference value is set based on the recorded anode pressure. The control device is also equipped with a monitoring module for further monitoring of the anode pressure during the opening duration of the outlet valve. With the aid of a determination module, an anode pressure deviation of the monitored anode pressure from the set anode pressure reference value is determined. In addition, a closing module is provided for closing the outlet valve when the determined anode pressure deviation exceeds a deviation threshold. The opening module, the recording module, the setting module, the monitoring module, the determination module and/or the closing module are in particular designed to carry out an inspection method according to the invention. Thus, a control device according to the invention brings the same advantages as have been explained in detail with reference to an inspection method according to the invention.

The subject matter of the present invention also includes a computer program product comprising commands which, when executed by a computer, cause it to perform the steps of an inspection method according to the invention. Thus, a computer program product according to the invention also brings the same advantages as have been explained in detail with reference to an inspection method according to the invention.

In addition, the subject matter of the present invention also includes a fuel cell system for the generation of electrical power. This fuel cell system has a fuel cell stack with an anode section and a cathode section. The anode section is equipped with an anode supply section for the supply of anode supply gas and an anode exhaust gas section for the discharge of anode exhaust gas. The cathode section is designed with a cathode supply section for the supply of cathode supply gas and a cathode discharge section for the discharge of cathode exhaust gas. Such a fuel cell system is characterised in that a liquid container is arranged in the anode exhaust gas section to collect separated liquid from the anode exhaust gas, with an outlet valve for discharging the collected liquid. A control device according to the present invention is also arranged therein. Thus, a fuel cell system according to the invention brings the same advantages as have been explained in detail with reference to an inspection method according to the invention.

Further advantages, features and details of the invention are explained in the following description, in which exemplary embodiments of the invention are described in detail with reference to the drawings. In each case schematically:

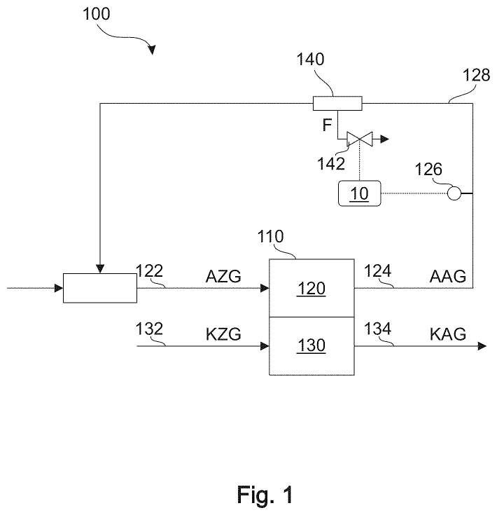

FIG. 1 shows an embodiment of a fuel cell system according to the invention,

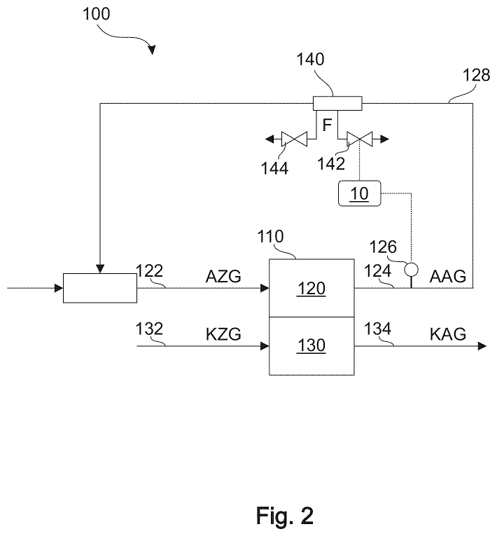

FIG. 2 shows a further embodiment of a fuel cell system according to the invention,

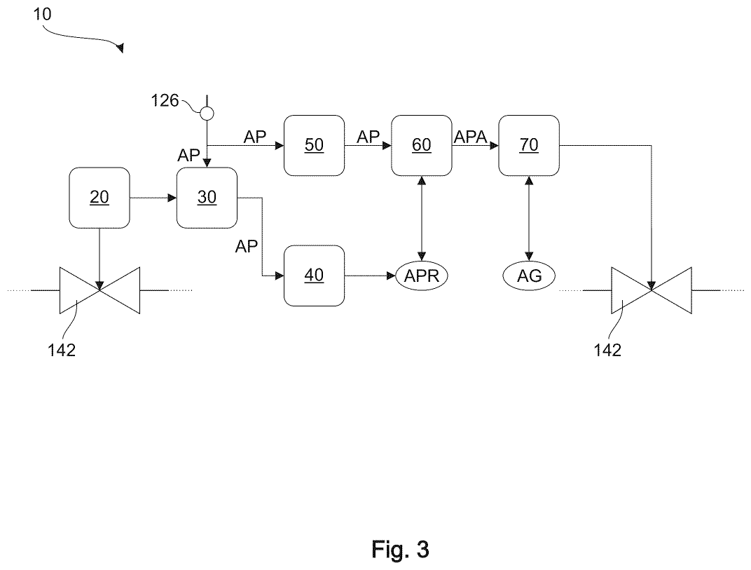

FIG. 3 shows an embodiment of a control device according to the invention,

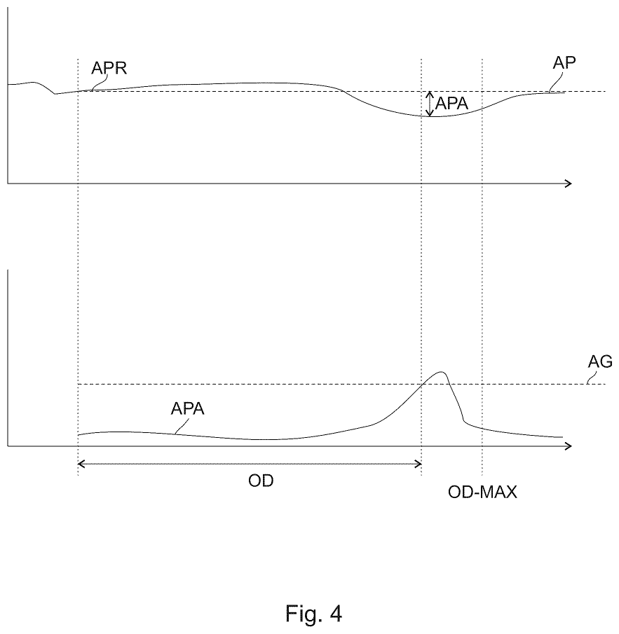

FIG. 4 shows a possible sequence of a method according to the invention,

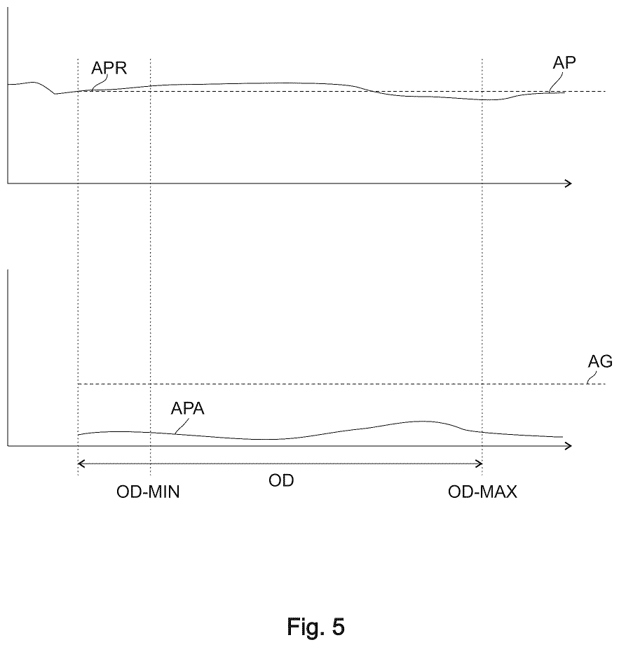

FIG. 5 shows a further possible sequence of a method according to the invention,

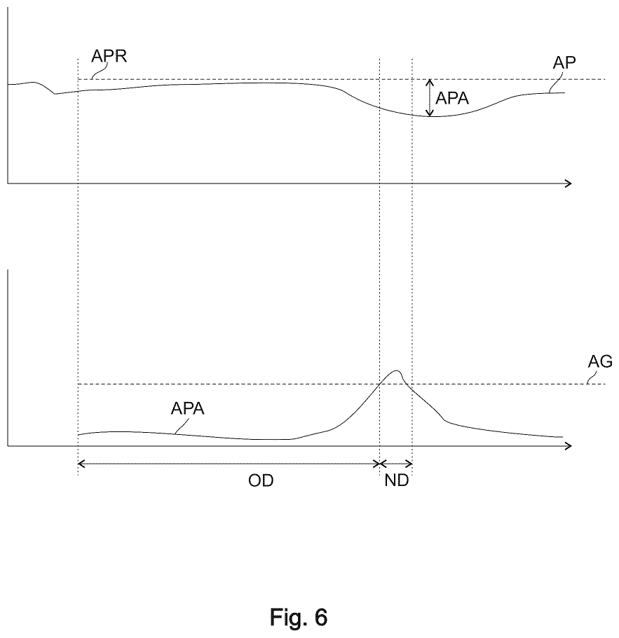

FIG. 6 shows a further possible sequence of a method according to the invention.

FIG. 1 shows, schematically, a fuel cell system 100 with a fuel cell stack 110. This fuel cell stack 110 is divided schematically into an anode section 120 and a cathode section 130. Anode supply gas AZG is supplied to the anode section 120 via an anode supply section 122. In particular, the anode supply gas AZG contains a defined amount of fuel, which can now react chemically within the fuel cell stack 110 with the cathode supply gas KZG supplied via the cathode supply section 132 in a defined way to generate electricity. This produces cathode exhaust gas KAG, which can be discharged, in particular into the environment, via the cathode discharge section 134. The anode exhaust gas AAG which is produced is passed out of the anode section 120 of the fuel cell stack 110 via the anode exhaust gas section 124 and recirculated via the recirculation section 128. The recirculated anode exhaust gas AAG, which can also be referred to as recirculation gas, is loaded with water through the chemical reaction processes within the fuel cell stack 110. This water can be in both liquid and gaseous phases. In order to separate at least the liquid water, a water separator (not shown) is provided which is in particular integrated into the liquid container 140. The liquid container 140 therefore serves at least to receive and collect the liquid F, but in particular also to separate this liquid from the anode exhaust gas AAG in the recirculation section 128. Since the liquid container 140 has a finite collection volume, the collected liquid F can be discharged here into the environment via an outlet valve 142. In order to control this process, which can also be referred to as the drain process, a control device 10 is provided which can for example be designed according to FIG. 3. As an input parameter, the control device 10 is in this case therefore connected, in a signal-communicating manner, not only to the outlet valve 142 but also to an anode pressure sensor 126.

FIG. 2 is based on the embodiment shown in FIG. 1 and also shows a similar fuel cell system 100. However, this has been supplemented in such a way that a degassing valve 144 is now also provided in the recirculation section 128, here at the end of the water-separating liquid container 140, for a separate purge process which is to be carried out. In particular, it is therefore possible to carry out, via two separate valves, both the purge process in the form of the degassing valve 144 and the drain process via the outlet valve 142. Furthermore, in the embodiment of FIG. 2a, a more indirect determination is now provided for, since the anode pressure sensor 126 is now integrated, not into the recirculation section 128, but directly into the anode exhaust gas section 124 at the outlet of the fuel cell stack 110.

The sequence of a method according to the invention is now explained schematically with reference to a control device 10 as shown in FIG. 3. The outlet valve 142 shown on the left and right is the same here, with the opening process shown on the left-hand side of FIG. 3 and the closing process on the right-hand side of FIG. 3.

According to FIG. 3, the control device 10 starts in that, for example on the basis of an external specification, for example on the basis of a defined maximum fill level within the liquid container 140, the opening module 20 opens the outlet valve 142. Thus, the liquid F can now leave the liquid container 140 via the outlet valve 142, for example under the force of gravity or due to the overpressure in the anode exhaust gas section 124. At this time, i.e. exactly at the time of opening with the aid of the opening module 20, the anode pressure AP is recorded, in this case by the anode pressure sensor 126 of the recording module 30. This recorded anode pressure AP is passed on to a setting module 40 where it is set, either directly or with a safety margin, as the anode pressure reference value APR.

During the further opening process, a preferably continuous monitoring of the anode pressure AP takes place, again via the anode pressure sensor 126, now with the aid of the monitoring module 50. The monitoring module 50 now transfers the recorded and continuously monitored anode pressure AP to a determination module 60 which can determine an anode pressure deviation APA compared to the set anode pressure reference value APR, again in a continuous manner. In the final step, with the aid of the closing module, a comparison of the determined anode pressure deviation APA from an anode pressure deviation threshold AG is determined and a closing command is issued to the outlet valve 142 as soon as the anode pressure deviation APA exceeds the specified anode pressure threshold. This time correlation differs and depends on the actual mode of operation of the fuel cell system and is in particular explained with reference to the following figures.

FIG. 4 shows a possible progression of the parameters in an inspection method according to the invention. The time axes are plotted from left to right, whereby different parameters are considered. The upper diagram shows the progression of the anode pressure AP. The dashed vertical line on the left represents the start of the opening process and thus the beginning of the opening duration OD. At this point, the anode pressure AP recorded exactly at the time of opening is set, in this case without any margin, as the anode pressure reference value APR, as can be seen in the upper diagram. Over the further progression, the anode pressure AP increases slightly and then decreases sharply after a certain period of time. This difference is continuously monitored as the anode pressure deviation APA and is plotted separately in the lower diagram over the same period of time. At the beginning of the opening duration OD, the anode pressure AP runs just above or just below the anode pressure reference value APR so that, accordingly, the anode pressure deviation APA remains substantially constant. As soon as the anode pressure deviation APA becomes significantly larger, this continues to increase, such that a deviation threshold AG is exceeded, as can be seen in the lower diagram. The time at which the deviation threshold AG is exceeded represents the signal that leads to the closing of the outlet valve 142 and thus to the termination of the opening duration OD. Here it is easy to see that, after the outlet valve 142 is closed, the anode pressure AP rises again and, accordingly, the anode pressure deviation APA decreases again.

FIG. 5 shows a similar situation to that in FIG. 4, but the anode pressure AP does not sink so far that an anode pressure deviation APA would exceed the deviation threshold AG. Nevertheless, an inspection method according to the invention now closes the outlet valve 142 after a defined opening duration OD, i.e. when the maximum opening duration OD-MAX has been reached. In addition, a minimum opening duration OD-MIN is also specified here, so that in this embodiment of the inspection method a minimum OD-MIN and a maximum opening duration OD-MAX are each specified as a limiting corridor for the inspection method.

FIG. 6 also shows a development of an inspection method according to the invention with regard to several features, which can of course be freely combined with each other. For example, at the beginning of the opening process, and thus at the start of the opening duration OD, in the upper diagram the anode pressure AP prevailing at this opening time is not set directly as the anode pressure reference value APR. Rather, a safety margin is provided and the anode pressure reference value APR is accordingly higher by this safety margin than the anode pressure AP recorded at this opening time. This leads to a higher anode pressure deviation APA resulting over the entire curve which includes this safety margin, and the anode threshold AG is exceeded at an earlier point in time compared to FIG. 4, as shown in the lower diagram in FIG. 6. The opening duration OD is accordingly shorter than in FIG. 4.

In addition, an over-run duration ND is also recorded for this embodiment, i.e. the time remaining after the deviation limit AG has been exceeded and the outlet valve 142 has in consequence been closed until the anode pressure deviation APA falls below the deviation threshold AG again.

The above explanation of the embodiments describes the present invention exclusively in the context of examples.

### LIST OF REFERENCE SIGNS

10 control device
20 opening module
30 recording module
40 setting module
50 monitoring module
60 determination module
70 closing module
100 fuel cell system
110 fuel cell stack
120 anode section
122 anode supply section
124 anode exhaust gas section
126 anode pressure sensor
128 recirculation section
130 cathode section
132 cathode supply section
134 cathode discharge section
140 liquid container
142 outlet valve
144 degassing valve
OD opening duration
OD-MAX maximum opening duration
OD-MIN minimum opening duration
AP anode pressure
APR anode pressure reference value
APA anode pressure deviation
AG deviation threshold
ND over-run duration
F liquid
AZG anode supply gas
AAG anode exhaust gas
KZG cathode supply gas

1. Inspection method for controlling an opening duration (OD) of an outlet valve (142) of a liquid container (140) in an anode exhaust gas section (124) of a fuel cell system (100), characterised by the following steps:
opening the outlet valve (142) to drain liquid (F) from the liquid container (140),
recording the anode pressure (AP) in the anode exhaust gas section (124) at the time of opening the outlet valve (142),
setting an anode pressure reference value (APR) based on the recorded anode pressure (AP),
further monitoring of the anode pressure (AP) during the opening duration (OD) of the outlet valve (142),
determining an anode pressure deviation (APA) of the monitored anode pressure (AP) from the set anode pressure reference value (APR),
closing the outlet valve (142) when the determined anode pressure deviation (APA) exceeds a deviation threshold (AG).

2. Inspection method according to claim 1, wherein a maximum opening duration (OD-MAX) is specified, wherein the outlet valve (142) is closed when the maximum opening duration (OD-MAX) is reached.

3. Inspection method according to claim 2, wherein the maximum opening duration (OD-MAX) is specified on the basis of at least one operating parameter of the fuel cell system (100).

4. Inspection method according to claim 1, wherein a minimum opening duration (OD-MIN) is specified, wherein the outlet valve (142) remains open at least during the minimum opening time (OD-MIN).

5. Inspection method according to claim 1, wherein, during the opening duration (OD) and/or after the closing of the outlet valve (142), a discharged amount of liquid (F) is determined on the basis of the opening duration (OD).

6. Inspection method according to claim 1, wherein the anode pressure reference value (APR) corresponds exactly to the recorded anode pressure (AP) at the time of opening the outlet valve (142).

7. Inspection method according to claim 1, wherein the anode pressure reference value (APR) corresponds to the recorded anode pressure (AP) at the time of opening the outlet valve (142) plus a safety margin.

8. Inspection method according to claim 1, wherein the anode pressure reference value (APR) is varied over the opening duration (OD) on the basis of an anode supply pressure in an anode supply section (122) of the fuel cell system (100).

9. Inspection method according to claim 1, wherein a over-run duration (ND) is determined, from the exceeding of the deviation threshold (AG) until the deviation threshold (AG) is complied with again after the outlet valve (142) has been closed, wherein, in particular on the basis of the determined over-run duration (ND), an amount of anode exhaust gas (AAG) lost through the opened outlet valve (142) is determined.

10. Control device (10) for controlling an opening duration (OD) of an outlet valve (142) of a liquid container (140) in an anode exhaust gas section (124) of a fuel cell system (100), wherein an opening module (20) for opening the outlet valve (142) to discharge liquid (F) from the liquid container (140), a recording module (30) for recording the anode pressure (AP) in the anode exhaust gas section (124) at the time of opening the outlet valve (142), a setting module (40) for setting an anode pressure reference value (APR) based on the recorded anode pressure (AP), a monitoring module (50) for further monitoring of the anode pressure (AP) during the opening duration (OD) of the outlet valve (142), a determination module (60) for determining an anode pressure deviation (APA) of the monitored anode pressure (AP) from the set anode pressure reference value (APR) and a closing module (70) for closing the outlet valve (142) when the determined anode pressure deviation (APA) exceeds a deviation threshold (AG), wherein the opening module (20), the recording module (30), the setting module (40), the monitoring module (50), the determination module (60) and/or the closing module (70) are in particular designed to carry out one of the inspection methods with the features of claim 1.

11. Computer program product comprising commands which, when executed by a computer, cause it to perform the steps of an inspection method with the features of one of claim 1.

12. Fuel cell system (100) for generating electrical power, comprising a fuel cell stack (110) with an anode section (120) and a cathode section (130), wherein the anode section (120) has an anode supply section (122) for the supply of anode supply gas (AZG) and an anode exhaust gas section (124) for the discharge of anode exhaust gas (AAG), wherein the cathode section (130) further has a cathode supply section (132) for the supply of cathode supply gas (KZG) and a cathode discharge section (134) for the discharge of cathode exhaust gas (KAG), wherein a liquid container (140) is arranged in the anode exhaust gas section (124) to collect separated liquid (F) from the anode exhaust gas (AAG), with an outlet valve (142) for draining the collected liquid (F) and a control device (10) with the features of claim 10.
